(19) United States
(12) Patent Application Publication
(10) Pub. No.: US 2021/0364228 A1
(43) Pub. Date: Nov. 25, 2021

(54) INSTALLATION AND METHOD FOR PRODUCING LIQUEFIED METHANE

(71) Applicant: L'Air Liquide, Societe Anonyme pour I'Etude et I'Exploitation des Precedes Georges Claude, Paris (FR)

(72) Inventors: Jean-Marc BERNHARDT, La Buisse (FR); Mathieu ROIG, Grenoble (FR)

(21) Appl. No.: 17/286,057

(22) PCT Filed: Sep. 26, 2019
(86) PCT No.: PCT/FR2019/052275

§ 371 Date: Apr. 16, 2021

(30) Foreign Application Priority Data
Oct. 18, 2018 (FR) 1859623

(51) Int. Cl. F25J 1/00; F25J 3/08; C07C 1/12

(52) U.S. Cl. CPC F25J 1/0022; F25J 3/08; C07C 1/12; F25J 2220/82; F25J 2205/64; F25J 2205/62; F25J 2215/60

(57) ABSTRACT

A plant for the production of liquefied methane having, arranged in series, a means for the generation of methane from hydrogen and carbon dioxide, a means for drying the gas mixture produced by the methane generation means, a purification means configured to remove carbon dioxide from the gas mixture dried in the drying means, a liquefier configured to liquefy the methane contained in the gas mixture purified in the purification means, and a liquefied gas storage facility configured to store the methane liquefied by the liquefier.

### CROSS REFERENCE TO RELATED APPLICATIONS

This application is a 371 of International Application No. PCT/FR2019/052275, filed Sep. 26, 2019, which claims priority to French Patent Application No. 1859623, filed Oct. 18, 2018, the entire contents of which are incorporated herein by reference.

### BACKGROUND

The invention relates to a plant and a process for the production of liquefied methane.

The invention relates more particularly to a plant for the production of liquefied methane comprising, arranged in series in a circuit, a means for generation of methane from hydrogen and carbon dioxide, such as a methanation reactor, a means for drying the gas mixture produced by the methane generation means, a purification means configured in order to remove carbon dioxide from the gas mixture dried in the drying means, a liquefier configured in order to liquefy the methane contained in the gas mixture purified in the purification means, and a liquefied gas storage facility configured in order to store the methane liquefied by the liquefier.

During methanation processes, that is to say processes for the generation of methane (CH₄) from carbon dioxide (CO₂) and hydrogen (H₂), the methane produced generally contains carbon dioxide and hydrogen in proportions of the order of 1% to 4% each.

For the purpose of liquefying this gas, a purification is necessary upstream of the liquefier.

Purification from carbon dioxide can be carried out in the same way as on “biomethane” production units, but the hydrogen virtually does not condense at the temperature of the liquid methane and remains in the form of a gas (two-phase mixture which is a function of the pressure). The hydrogen is concentrated in the vapor phase and must be discharged during the liquefaction of the methane.

The source hydrogen for the methanation reaction can originate from the electrolysis of water or from another production source. Its recovery during the liquefaction and its recycling to the methanation reactor increases the degree of conversion of the hydrogen and thus the methane production. The presence of methane in the recycled gas must be reduced as much as possible because it knits the reaction (being one of the products thereof).

The purification of methane with a view to its liquefaction is a known process. In the case of biomethane resulting from biogas purification (methanization process), the final purification before liquefaction makes it possible to remove the compounds which can solidify, such as CO₂ (1% to 3%) and water (trace amounts). Cf. FR 2 969 008, relating to processes with cooling of the purification stage and heat recovery for the regeneration stage.

Cf. also U.S. Pat. No. 6,931,889, which relates to the recovery of hydrogen by a cryogenic process on a gas rich in hydrocarbons. This solution proposes to heat the products (rich in H₂ and rich in hydrocarbons) for use in the gaseous form.

### SUMMARY

One aim of the present invention is to overcome all or some of the abovementioned disadvantages of the prior art.

To this end, the plant according to the invention, moreover in accordance with the generic definition given therefor in the above preamble, is essentially characterized in that it comprises a hydrogen separation device configured in order to remove at least a part of the hydrogen in the fluid mixture produced by the liquefier before it enters the storage facility.

This makes possible a separation of the hydrogen while limiting the amount of methane leaving with this separated hydrogen.

Furthermore, embodiments of the invention can comprise one or more of the following characteristics:
the purification means comprises a pressure and temperature swing adsorber comprising an outlet for the effluent gases comprising methane and hydrogen, said outlet being connected, via a return pipe, to a feed inlet of the methane generation means in order to be recycled therein,
the hydrogen separation device comprises an outlet for the separated gas mixture comprising methane and hydrogen, said outlet being connected, via a recycling pipe, to an inlet of the methane generation means in order to be recycled therein,
the recycling pipe comprises a means for reheating the gas mixture before it enters the methane generation means,
the storage facility is configured in order to contain liquefied methane in equilibrium with a gas mixture, the storage facility comprising a gas discharge pipe connecting the gaseous part of the storage facility to an inlet of the methane generation means,
the hydrogen separation device comprises a first phase-separating vessel comprising an inlet connected to an outlet of the liquefier, in order to receive the fluid mixture produced by the liquefier, and two outlets respectively connected to a pipe for transfer of liquid to the storage facility and a pipe for transfer of gas to the methane generation means,
the hydrogen separation device is connected to the outlet of the liquefier via an expansion valve, the plant being configured in order to cool the mixture of fluids at the outlet of the liquefier to a temperature lower than the equilibrium temperature of pure methane,
the plant comprises, arranged in series on the pipe for transfer of gas to the methane generation means, a means for cooling the gas, in particular a heat exchanger cooled by a cold source, and a second phase-separating vessel comprising an inlet connected to a gas outlet of the first phase-separating vessel and two outlets respectively connected to the pipe for transfer of liquid to the storage facility and to the pipe for transfer of gas to the methane generation means,
the hydrogen separation device comprises a first phase-separating vessel comprising an inlet connected to an outlet of the liquefier in order to receive the fluid mixture produced by the liquefier, a first outlet connected, via a reheating heat exchanger, to a membrane separation device configured to separate the methane and the hydrogen, the membrane separation device comprising an outlet for gas enriched in methane and hydrogen connected to an inlet of the liquefier for the purpose of its liquefaction, and an outlet for hydrogen-rich effluents connected to an inlet of the methane generation means, the first phase-separating vessel comprising a second liquid outlet connected to the inlet of a second phase-separating vessel.

The invention also relates to a process for the production of liquefied methane from a production plant comprising, arranged in series in a circuit, a means for generation of methane from hydrogen and carbon dioxide, such as a methanation reactor, a means for drying the gas mixture produced by the methane generation means, a purification means configured in order to remove carbon dioxide from the gas mixture dried in the drying means, a liquefier configured in order to liquefy the methane contained in the gas mixture purified in the purification means, and a liquefied gas storage facility configured in order to store the methane liquefied by the liquefier, the process comprising a stage of separation of hydrogen from the fluid mixture produced by the liquefier before it is transferred into the storage facility.

According to other possible distinguishing features:
the hydrogen separation stage comprises at least one from: a liquid/vapor phase separation in at least a separating vessel, a cooling of the fluid mixture, a reheating of the mixture of fluids, a separation by membranes.

The invention may also relate to any alternative device or process comprising any combination of the characteristics above or below within the scope of the claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 represents a diagrammatic and partial view illustrating an example of structure and operation of a plant according to the invention,

FIG. 2 represents a diagrammatic and partial view illustrating a detail of the plant of FIG. 1 according to a distinct embodiment,

FIG. 3 represents a diagrammatic and partial view illustrating a detail of the plant of FIG. 1 according to another distinct embodiment,

FIG. 4 represents a diagrammatic and partial view illustrating a detail of the plant of FIG. 1 according to another distinct embodiment.

### DETAILED DESCRIPTION OF PREFERRED EMBODIMENTS

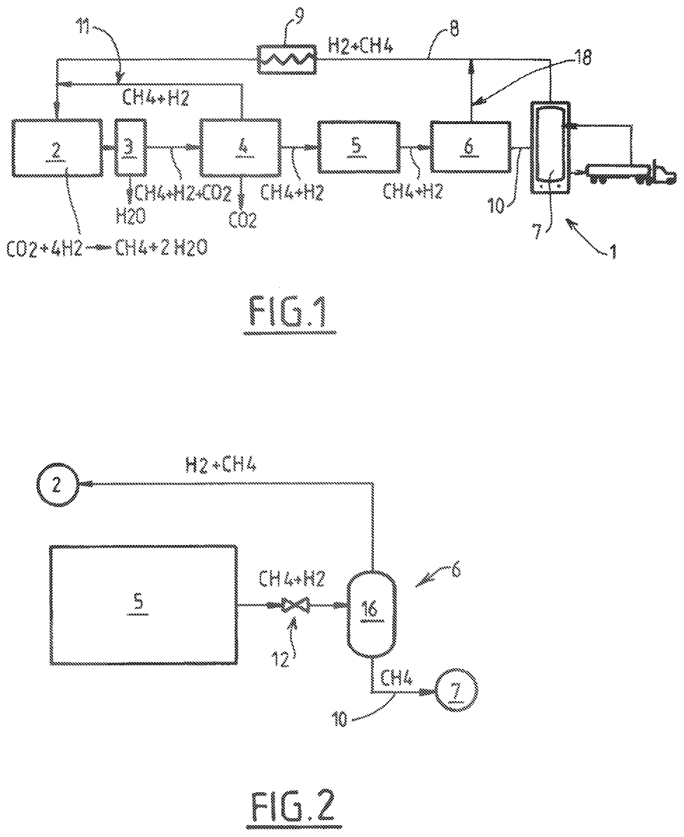

The plant 1 for the production of liquefied methane represented diagrammatically in FIG. 1 comprises, arranged in series in a circuit 10, a means 2 for generation of methane from hydrogen and carbon dioxide, such as a methanation reactor, a means 3 for drying the gas mixture produced by the methane generation means 2, a purification means 4 configured in order to remove carbon dioxide from the gas mixture dried in the drying means 3, a liquefier 5 configured in order to liquefy the methane contained in the gas mixture purified in the purification means 4, and a liquefied gas storage facility 7 configured in order to store the methane liquefied by the liquefier 5. In addition, the plant 1 comprises a hydrogen separation device 6 configured in order to remove at least a part of the hydrogen from the fluid mixture produced by the liquefier 5 before it enters the storage facility 7. For example, the hydrogen separation device 6 is located between the liquefier 5 and the storage facility 7.

The means 2 for the generation of methane from hydrogen and carbon dioxide can conventionally produce methane according to the reaction CO₂+4H₂→CH₄+2H₂O.

The drying means 3 can, for example, be a condensation and/or adsorption system configured in order to dry the gas mixture, that is to say withdrawal of the water (H₂O) to an outlet, as illustrated in FIG. 1.

The purification means 4 thus receives at the inlet a gas mixture comprising methane (CH₄), hydrogen (H₂) and CO₂.

The purification means 4 preferably comprises a pressure and temperature swing adsorber (PTSA) configured in order to remove CO₂ from the gas to be liquefied. This purification means 4 comprises an outlet for the effluent gases comprising hydrogen (H₂) and a methane residue. This outlet is connected, via a return pipe 11, to a feed inlet of the methane generation means 2 in order to be recycled therein. The CO₂ removed in the purification means 4 can be discharged via another outlet. The purified mixture (CH₄ predominant and H₂ residue) is supplied to an inlet of the liquefier 5.

The liquefier 5 can, for example, be a liquefier of the “Turbo Brayton” type, such as sold by Air Liquide and making possible refrigeration and liquefaction from 25 K to 200 K in particular.

The liquefier 5 produces, at the outlet, liquefied methane with a hydrogen gas residue.

The impurities separated during the liquefaction (hydrogen with methane residues) can be discharged by an outlet connected via a recycling pipe 18, 8 to an inlet of the methane generation means 2 in order to be recycled therein.

This liquefied purified mixture is supplied to an inlet of the hydrogen separation device 6. The hydrogen separation device 6 comprises an outlet for the purified fluid mixture (liquefied methane with very low hydrogen gas residues) which is supplied to the storage facility 7.

The hydrogen separation device 6 is configured in order to make it possible to separate the hydrogen at cryogenic temperature after (and/or during) the liquefaction of the methane.

As illustrated, the recycling pipe 8 preferably comprises a means 9 (heat exchanger or other) for reheating the relatively cold gas mixture which is returned to the methane generation means 2.

The storage facility 7 is, for example, a vacuum-insulated cryogenic tank configured in order to contain liquefied methane in equilibrium with a gas mixture. The storage facility 7 preferably comprises a gas discharge pipe 8 connecting the gaseous part of the storage facility 7 (upper part) to an inlet of the methane generation means 2 for the purpose of recycling the vaporization gas (H₂ and CH₄ residues) therein.

This arrangement makes it possible to concentrate the hydrogen in the low-pressure recycled gas and to return this mixture to the methanation reactor (means 2).

FIGS. 2 to 4 illustrate several possible nonlimiting examples of the hydrogen separation device 6.

In the embodiment of FIG. 2, this separation can be carried out by a simple liquid/vapor separation.

The hydrogen separation device 6 comprises a single phase-separating vessel 16 comprising an inlet connected to an outlet of the liquefier 5, in order to receive the fluid mixture produced by the liquefier, and two outlets respectively connected to a pipe 10 for transfer of liquid to the storage facility 7 and a pipe 18, 8 for transfer of gas to the methane generation means 2. The hydrogen separation device 6 can be connected to the outlet of the liquefier 5 via an expansion valve 12. The plant 1 can thus be configured in order to cool the mixture of fluids at the outlet of the liquefier 5 to a temperature lower than the equilibrium temperature of pure methane. That is to say that the entire flow of the CH₄+H₂ mixture is cooled to a lower temperature (for example approximately 105 K) than the equilibrium temperature of CH₄ alone (110 K at 1 bar). At the outlet of the liquefier 5, the mixture can be at a temperature of approximately 100 to 105 K and a pressure of 10 bar. The expansion valve 12 can be configured in order to carry out a “flash” expansion. The methane can be in the storage facility at a temperature of between 100 and 105 K and a pressure of 2 bar. The liquid methane withdrawn from the storage facility 7 can have a temperature of 110 K at a pressure slightly greater than atmospheric pressure.

In the embodiment of FIG. 3, the hydrogen separation device comprises an additional cooling of the vapors.

More specifically, the hydrogen separation device 6 comprises, arranged in series at the outlet of the liquefier 5, an expansion valve 12, a first phase-separating vessel 16, the gas outlet of which is connected, via a means 13 for cooling the gas, to a second phase-separating vessel 26. The cooling means 13 is, for example, a heat exchanger cooled by a cold source. A gas outlet (hot side) of the second phase-separating vessel 26 can be connected as above to the pipe 8 for transfer of gas to the methane generation means 2. The liquid outlets of the two separating vessels 16, 26 can for their part be connected in parallel to the pipe 10 for transfer of liquid to the storage facility 7 in order to transfer the liquid therein.

The additional cooling of the vapors carried out between the two separating vessels 16, 26 can be carried out with cold originating from the liquefier 5 and/or from an external cold source, such as liquid nitrogen, for example.

Only the vapors laden with hydrogen (H₂) (at a relatively low flow rate) are cooled to a lower temperature (for example to a temperature of less than or equal to 92 K). This makes it possible to limit the need for the production of cold from the liquefier 5 or the consumption of liquid N₂, if necessary. The electrical consumption of the plant 1 is thus reduced.

This also makes it possible to increase the concentration of hydrogen in the gas recycled to the means 2 when the temperature of the gas at the exchanger 13 outlet decreases.

At the outlet of the liquefier 5, the mixture can, for example, be at a temperature of approximately 110 to 120 K and a pressure of 10 bar.

In the first separating vessel 16, the fluid has, for example, a temperature of approximately 110 to 120 K and a pressure of 2 to 10 bar.

Downstream of the exchanger 13, the fluid has, for example, a temperature of approximately 92 to 105 K and a pressure of approximately 2 bar.

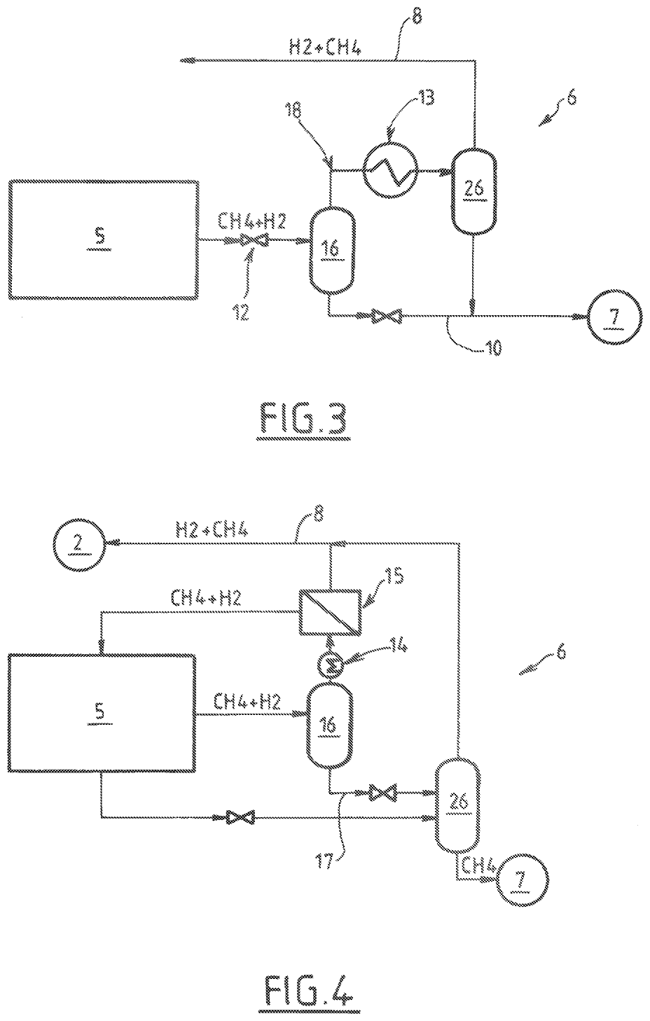

In the embodiment of FIG. 4, there is separation of the hydrogen from the vapors via a separation device of cold membrane type.

The hydrogen separation device 6 comprises a first phase-separating vessel 16 comprising an inlet connected to an outlet of the liquefier 5 in order to receive the fluid mixture produced by the liquefier. The first phase-separating vessel 16 comprises a first vapor outlet (“hot gases”) connected, via a reheating means 14 (heat exchanger, for example), to a membrane separation device 15 configured in order to separate the methane and the hydrogen. Membrane separation device 15 denotes in particular a device for separation by membrane permeation.

The membrane separation (purification) device 15 comprises, for example, an outlet for gas enriched in methane and hydrogen connected to an inlet of the liquefier 5 for the purpose of its liquefaction. The membrane separation device 15 comprises another outlet for hydrogen-rich effluents connected to an inlet of the methane generation means 2. The first phase-separating vessel 16 comprises a second liquid outlet connected to the inlet of a second phase-separating vessel 26.

The second phase-separating vessel 26 comprises a gas outlet connected to the pipe 8 for transfer of gas to the methane generation means 2 and a liquid outlet connected to the storage facility 7.

Thus, after high-pressure liquid/vapor separation of the methane in the first vessel 16, the vapor is extracted and then can be reheated by a few degrees before entering a cold membrane 15 (to avoid condensation in the membrane 15). The low-pressure part of the vapors (rich in H₂) can return with recycling to the reactor 2. The high-pressure part of the vapors resulting from the membrane 15 returns to the liquefier 5 (or an exterior liquid N₂ cold source) in order to be cooled again, expanded and separated with the liquid coming from the first separator. The vapor (rich in H₂) from the second vessel 26 can join that at the outlet of the membranes. The liquefier 5 can comprise an additional liquid outlet which is connected to the second vessel 26.

As above, the temperature at the outlet of the liquefier can be of the order of 110 to 120 K (ditto in the first vessel 16 or second vessel 26). The vapors can be reheated in the exchanger 14 to between 115 and 125 K.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-10. (canceled)

11. A plant for the production of liquefied methane comprising a circuit comprising, arranged in series, a means for the generation of methane from hydrogen and carbon dioxide, a means for drying the gas mixture produced by the methane generation means, a purification means configured to remove carbon dioxide from the gas mixture dried in the drying means, a liquefier configured to liquefy the methane contained in the gas mixture purified in the purification means, and a liquefied gas storage facility configured to store the methane liquefied by the liquefier, the plant being comprising a hydrogen separation device configured in order to remove at least a part of the hydrogen from the fluid mixture produced by the liquefier before entering the storage facility, and wherein the hydrogen separation device comprises a first phase-separating vessel comprising an inlet connected to an outlet of the liquefier, in order to receive the fluid mixture produced by the liquefier, and two outlets respectively connected to a pipe for transfer of liquid to the storage facility and a pipe for transfer of gas to the methane generation means, wherein the hydrogen separation device is connected to the outlet of the liquefier via an expansion valve, the plant being configured to cool the mixture of fluids at the outlet of the liquefier to a temperature lower than the equilibrium temperature of pure methane.

12. The plant as claimed in claim 11, wherein the purification means comprises a pressure and temperature swing adsorber comprising an outlet for the effluent gases comprising methane and hydrogen, said outlet being connected, via a return pipe, to a feed inlet of the methane generation means in order to be recycled therein.

13. The plant as claimed in claim 11, wherein the hydrogen separation device comprises an outlet for the separated gas mixture comprising methane and hydrogen, said outlet being connected, via a recycling pipe, to an inlet of the methane generation means in order to be recycled therein.

14. The plant as claimed in claim 13, wherein the recycling pipe comprises a means for reheating the gas mixture before entering the methane generation means.

15. The plant as claimed in claim 11, wherein the storage facility is configured to contain liquefied methane in equilibrium with a gas mixture and in that the storage facility comprises a gas discharge pipe connecting the gaseous part of the storage facility to an inlet of the methane generation means.

16. The plant as claimed in claim 11, further comprising, arranged in series on the pipe for transfer of gas to the methane generation means, a means for cooling the gas, and a second phase-separating vessel comprising an inlet connected to a gas outlet of the first phase-separating vessel and two outlets respectively connected to the pipe for transfer of liquid to the storage facility and to the pipe for transfer of gas to the methane generation means.

17. The plant as claimed in claim 11, wherein a first outlet of the first phase-separating vessel is connected, via a reheating heat exchanger forming part of the plant, to a membrane separation device forming part of the plant configured in order to separate the methane and the hydrogen, the membrane separation device comprising an outlet for gas enriched in methane and hydrogen connected to an inlet of the liquefier for the purpose of liquefaction, and an outlet for hydrogen-rich effluents connected to an inlet of the methane generation means, the first phase-separating vessel comprising a second liquid outlet connected to the storage facility via a second phase-separating vessel.

18. The plant as claimed in claim 17, further comprising a pipe connecting a liquid outlet of the liquefier connected to an inlet of the second phase-separating vessel.

19. A process for the production of liquefied methane from a production plant in accordance with claim 11, the process comprising a stage of separation of hydrogen from the fluid mixture produced by the liquefier before being transferred into the storage facility, the hydrogen separation stage comprising at least one from: a liquid/vapor phase separation in at least separating vessel, a cooling of the fluid mixture, a reheating of the mixture of fluids, a separation by membranes in which the hydrogen separation device is connected to the outlet of the liquefier via an expansion valve, the plant being configured to cool the mixture of fluids at the outlet of the liquefier to a temperature lower than the equilibrium temperature of pure methane, and in which the entire flow of the CH₄+H₂ mixture is cooled to a lower temperature than the equilibrium temperature of CH₄ alone.

20. The process as claimed in 19, wherein the stage of separation of the hydrogen is carried out at a cryogenic temperature after and/or during the liquefaction of the methane.
